(19) United States
(12) Patent Application Publication
(10) Pub. No.: US 2010/0108514 A1
(43) Pub. Date: May 6, 2010

(54) METHOD OF CONTROLLING TEMPERATURE

(75) Inventors: Yoshihiro Seto, Ashigarakami-gun (JP); Tomohisa Kawabata, Mountain View, CA (US); Chungsoo Charles Park, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignee: FUJIFILM COPORATION, TOKYO (JP)

(21) Appl. No.: 12/593,875

(22) PCT Filed: Mar. 28, 2008
(86) PCT No.: PCT/US08/58566

§ 371 Date: Sep. 29, 2009

Related U.S. Application Data
(60) Provisional application No. 60/920,915, filed on Mar. 30, 2007.

(51) Int. Cl. G01N 27/26

(52) U.S. Cl. 204/454; 204/451

(57) ABSTRACT

To suppress temperature variations of sample fluids within flow channels for electrophoresis, in a method for controlling temperatures within micro flow channels. When controlling the temperatures of sample fluids within micro flow channels of electrophoresis chips, in which flow channels through which electrophoresis occurs by application of electrical potential differences can be switched, temperature variations of the sample fluids within the micro flow channels, caused by differences in heat generated by the sample fluids prior to and following the switching of the flow channels, are predicted. Control properties for temperature control in order to cancel the temperature variations are changed during the switching of the flow channels.

### CROSS-REFERENCE TO RELATED APPLICATION

This application claims priority from U.S. Provisional Application No. 60/920,815, filed Mar. 30, 2007 in the USPTO, the disclosure of which is incorporated herein in its entirety by reference.

### TECHNICAL FIELD

The present invention relates to a temperature controlling method, for controlling the temperature of sample fluids within micro flow channels of electrophoresis chips.

### BACKGROUND ART

A method for analyzing sample fluids, in which a sample fluid is housed in a unidirectionally extending capillary; and electrical potential differences are applied to the ends of the capillary, to cause electrophoresis to occur in the sample fluid, is known. When electrophoresis is caused, by applying the electrical potential difference to the sample fluid within the capillary, Joule heat is generated within the sample fluid due to current flowing therethrough, and the temperature thereof rises. If the temperature of the sample fluid varies in this manner, the viscosity and the like of the sample fluid also changes, thereby changing the state of electrophoresis therein. This may result in accurate analysis by electrophoresis not being able to be performed. For this reason, there is a known method for controlling the temperature of sample fluids contained in the capillaries to be a predetermined temperature when causing electrophoresis to occur (Patent Document 1).

There is also a known method, in which sample fluids are analyzed employing electrophoresis chips, in which fine flow channels (hereinafter, referred to as “micro flow channels” or simply “flow channels”) that branch out two dimensionally are formed on a substrate. The sample fluids are introduced into the micro flow channels and electrical potential differences are applied, to cause electrophoresis to occur.

A sample fluid can be analyzed by electrophoresis under two or more different conditions during analysis using the electrophoresis chips, by applying different electrical potential differences to different flow channels in which the sample fluids are contained, for example (Patent Document 2).

More specifically, for example, 3000V are applied to the two ends of a first micro flow channel of a electrophoresis chip having branched micro flow channels, to cause a specific component within a sample fluid contained in the flow channel to electrophorese and become concentrated at a region of the first micro flow channel. Then, application of the electrical potential difference to the first micro flow channel is ceased. Thereafter, 1500V are applied to the two ends of a second micro flow channel different from the first micro flow channel, to cause the concentrated specific component to disperse within the second micro flow channel by electrophoresis. The sample fluid is analyzed by measuring the dispersed state of the specific component within the second micro flow channel.

### [Patent Document 1]

Japanese Unexamined Patent Publication No. 7-20090

### [Patent Document 2]

U.S. Published Patent Application No. 2005/0121324

There is demand to more accurately analyze sample fluids using the electrophoresis chips having the two dimensionally branched micro flow channels by controlling the temperature of the sample fluids therein to be a predetermined temperature, in a manner similar to that applied to the sample fluids within the unidirectionally extending capillaries.

However, the amount of heat generated in the sample fluid within the first micro channel, to which 3000V are applied, differs from the amount of heat generated in the sample fluid in the second micro channel, to which 1500V are applied. Therefore, there are cases in which the sample fluid within the electrophoresis chip cannot be maintained accurately at a predetermined temperature.

That is, for example, if a sample fluid within an electrophoresis chip is to be maintained at a temperature within a predetermined range of 20° C.±0.5° C., temperature control properties are set such that an increase in temperature caused by heat generation due to application of an electrical potential difference within a first micro flow channel is canceled out. In this case, the temperature of the sample fluid can be maintained within the predetermined temperature range during electrophoresis within the first micro flow channel. However, when the flow channel to which an electrical potential difference is applied is switched to a second micro flow channel, the control properties may not be sufficient to cancel out an increase in temperature within the sample fluid. Therefore, the temperature of the sample fluid may change to that outside the predetermined temperature range.

Note that even if the electrical potential differences applied to each micro flow channel are the same prior to and following switching of the flow channels in which electrophoresis is caused to occur, the temperature of a sample fluid may change to that outside a predetermined temperature range, if the electrical resistance of each flow channel is different.

Note also that micro flow channels utilized for electrophoresis of sample fluids and electrical potential differences applied to the micro flow channels are determined according to the contents of analysis. Therefore, changes in the amount of heat generated within the sample fluids cannot be suppressed by adjusting the micro flow channels utilized for electrophoresis or the electrical potential differences applied thereto.

The present invention has been developed in view of the foregoing circumstances. It is an object of the present invention to provide a temperature controlling method capable of suppressing temperature variations in sample fluids, in which electrophoresis is caused to occur.

### DISCLOSURE OF THE INVENTION

A temperature controlling method of the present invention is a method for controlling the temperatures of sample fluids within micro flow channels of electrophoresis chips, in which flow channels through which electrophoresis occurs by application of electrical potential differences can be switched, characterized by:
predicting temperature variations of the sample fluids within the micro flow channels, caused by differences in heat generated by the sample fluids prior to and following the switching of the flow channels; and
changing control properties for temperature control in order to cancel the temperature variations during the switching of the flow channels.

The temperature control of the sample fluids may be performed by employing a Peltier element.

The applied electrical potential differences applied and the electrical resistance within the flow channels in which electrophoresis occurs, as well as the lengths and cross sectional areas of the flow channels may be different prior to and following the switching of the flow channels.

The control properties for temperature control may be changed either prior to or following the switching of the flow channels.

Note that the phrase “changing control properties for temperature control in order to cancel the temperature variations during the switching of the flow channels” is not limited to cases in which the timings of the control property change and the flow channel switching are perfectly matched. The timing at which the control properties are changed may be shifted either prior to or following the timing at which the flow channels are switched, within a range that does not hinder the cancellation of the temperature variations. That is, the temperature control properties may be changed prior to the switching of the flow channels, or following the switching of the flow channels, within a range that does not hinder the cancellation of the temperature variations.

According to the temperature controlling method of the present invention, temperature variations of the sample fluids within the micro flow channels, caused by differences in heat generated by the sample fluids prior to and following the switching of the flow channels, are predicted; and the control properties for temperature control are changed in order to cancel the temperature variations during the switching of the flow channels. Therefore, temperature variations of sample fluids in which electrophoresis is caused to occur can be suppressed.

That is, control properties that factor heat generation within the sample fluid due to application of the electrical potential difference prior to switching of the flow channels are switched to control properties that take heat generation within the sample fluid following switching of the flow channels, to cancel out the temperature variation that occurs when the flow channels are switched. Therefore, the temperature change that occurs prior to and following the switching of the flow channels can be suppressed, compared to conventional cases in which the control properties of temperature control are not changed. Thereby, changes in physical properties of the sample fluid in which electrophoresis is caused to occur, such as a change in viscosity, can be suppressed. Accordingly, electrophoresis within the sample fluid can be realized at conditions close to predetermined conditions, and the quality of analysis of the sample fluid can be improved.

The temperature control of the sample fluids may be performed by employing a Peltier element. In this case, temperature variations of the sample fluid can be more positively suppressed.

### BRIEF DESCRIPTION OF THE DRAWINGS

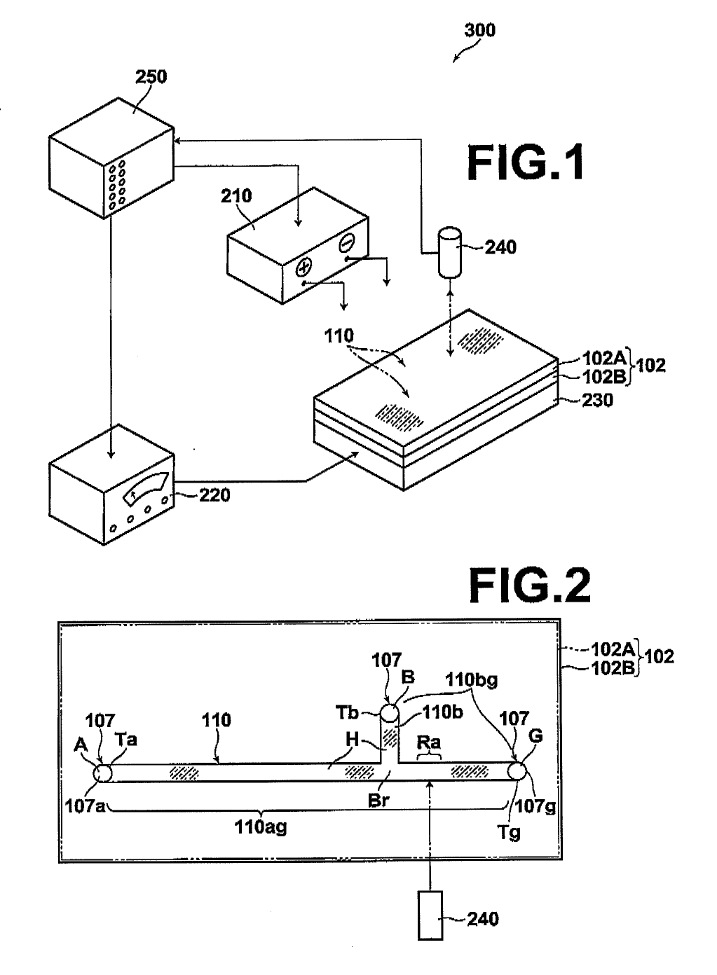

### [FIG. 1]

A conceptual view of an electrophoresis analysis apparatus, as an example of a temperature controlling apparatus that controls the temperature of electrophoresis chips using the temperature controlling method of the present invention

### [FIG. 2]

A plan view of an electrophoresis chip, in which switchable micro flow channels for electrophoresis are formed

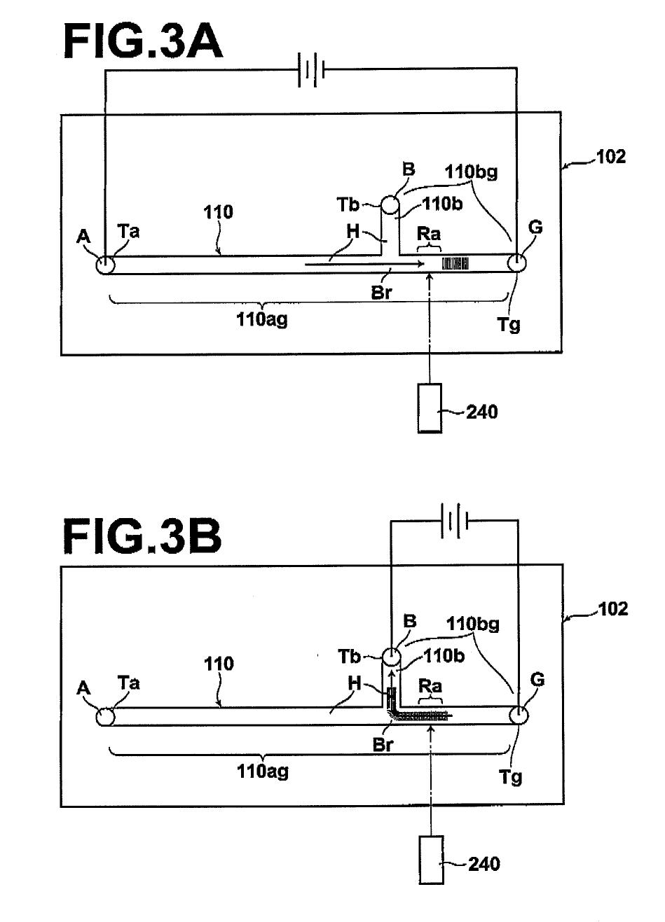

### [FIG. 3]

FIG. 3A is a diagram that illustrates a state in which a specific component in a sample fluid is caused to be concentrated by electrophoresis in a predetermined flow channel, and FIG. 3B is a diagram that illustrates a state in which the flow channel is switched, and the specific component is caused to disperse by electrophoresis

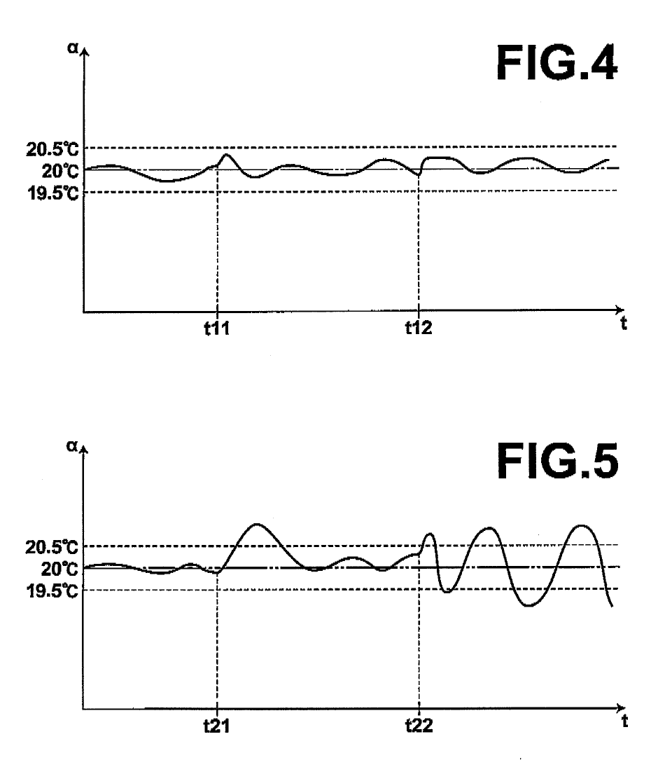

### [FIG. 4]

A graph that illustrates temperature variations of the sample fluid in the case that the temperature controlling method of the present invention is applied and electrophoresis flow channels are switched

### [FIG. 5]

A graph that illustrates temperature variations of the sample fluid in the case that a conventional temperature controlling method is applied

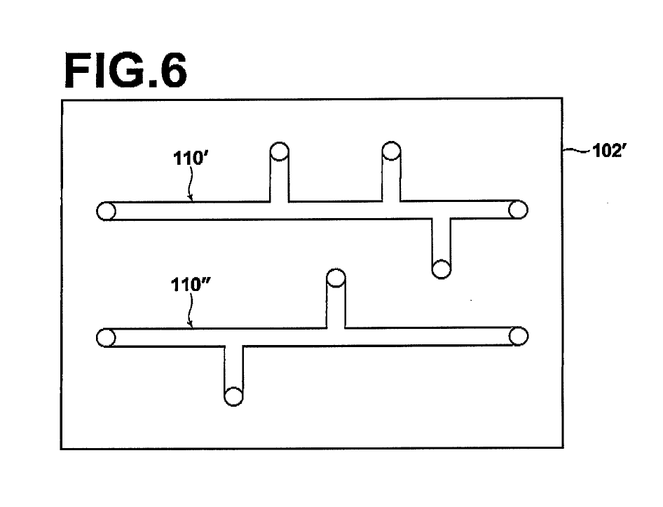

### [FIG. 6]

A diagram that illustrates an electrophoresis chip, in which two sets of independent micro flow channels are formed

### BEST MODE FOR CARRYING OUT THE INVENTION

Hereinafter, the temperature controlling method of the present invention will be described with reference to the attached drawings. FIG. 1 is a conceptual view of an electrophoresis analysis apparatus, as an example of a temperature controlling apparatus that controls the temperature of electrophoresis chips using the temperature controlling method of the present invention. FIG. 2 is a plan view of an electrophoresis chip, in which switchable micro flow channels for electrophoresis are formed. FIG. 3 illustrates the manner in which flow channels, to which electrical potential differences are applied to cause electrophoresis therein, are switched, wherein FIG. 3A is a plan view that illustrates a state in which a specific component in a sample fluid is caused to be concentrated by electrophoresis in a predetermined flow channel, and FIG. 3B is a plan view that illustrates a state in which the flow channel is switched, and the specific component is caused to disperse by electrophoresis.

The electrophoresis analysis apparatus 300 illustrated in FIG. 1 is equipped with: an electrophoresis chip 102, having switchable micro flow channels 110, to which electric potential differences are applied to cause electrophoresis therein, are formed; an electrical potential difference applying section 210, for applying electrical potential differences to flow channels in which electrophoresis is to be caused; a temperature controlling section 220, for controlling the temperature of the sample fluid contained in the flow channels of the electrophoresis chip; a Peltier element 230, for heating and cooling the sample fluid; a detecting section 240, for detecting the state of the sample fluid, in which electrophoresis is caused to occur; and a control section 250, for controlling the operations and timings of each component of the electrophoresis analysis apparatus 300.

The micro flow channels 110, in which electrophoresis is caused to occur, can be switched according to changes in the flow channels to which electrical potential differences are applied.

The temperature controlling section 220 predicts temperature variations of the sample fluids within the micro flow channels in which electrophoresis is caused to occur (hereinafter, also referred to as “electrophoresis flow channels”), caused by differences in heat generated by the sample fluids prior to and following the switching of the flow channels. The temperature controlling section 20 changes control properties for temperature control in order to cancel the temperature variations during the switching of the electrophoresis flow channels. That is, the control properties for temperature control with respect to the sample fluid in the electrophoresis flow channel following the switching of flow channels are changed during the switching of flow channels.

Note that it is desirable for the temperature control exerted with respect to the sample fluid within the electrophoresis flow channels to control the temperature of the entirety of the sample fluid within the micro flow channels formed in the electrophoresis chip 102. However, temperature control may be exerted separately in the electrophoresis flow channel prior to switching of the flow channels and in the electrophoresis flow channel following the switching of the flow channels.

As illustrated in FIG. 2, the electrophoresis chip 102 is constituted by two glass plates 102A and 102B. The micro flow channels 110 (hereinafter, also referred to simply as “flow channels 110”) are formed in one of the glass plates, the glass plate 102B in this case. The glass plates 102A and 102B are laminated onto each other such that the micro flow channels 110 are sandwiched therebetween, to form a single substrate. Both of the glass plates 102A and 102B may be transparent. Alternatively, only one of them, through which light is transmitted when optical measurement (to be described later) is performed, may be transparent.

As illustrated in FIG. 2, apertures having inner diameters of 1.2 mm, that is, well apertures 107, are formed in the electrophoresis chip 102 on the side of the glass plate 102A. The well apertures are positioned with respect to the flow channels 110, and penetrate through the glass plate 102A to communicate with the flow channels 110 of the glass plate 102B.

Accordingly, when a sample fluid H containing reagents and samples are injected into the well apertures 107, the sample fluid H is introduced to the flow channels 110. Note that the electrophoresis chip 102 may be formed by a synthetic resin, instead of glass.

Next, the flow channels 110 will be described. The flow channels 110 are 100 μm wide and 15 μm deep, for example. The flow channels 110 are formed by a micro processing technique, such as etching or photolithography. As will be described later, electrophoresis chips, in which two or more sets of independent flow channels that do not communicate with each other are formed, may be employed.

The flow channels 110 are constituted by: a main flow channel 110ag that extends linearly in the horizontal direction of FIG. 2, and a shorter sub flow channel 110b that branches from the main flow channel 110ag at a right angle and extends for a short distance. A well aperture 107a is formed above the left end Ta of the main flow channel 110ag, and a well aperture 107g is formed above the right end Tg of the main flow channel 110ag. A well aperture 107b is formed above the end Tb of the sub flow channel 110b, which is the end opposite that which branches from the main flow channel 110ag.

Note that a measurement target substance is detected by the detecting section 240, which is equipped with an optical system, in a detection target region Ra within the main flow channel 110ag. That is, the detecting section 240 detects the measurement target substance included in the sample fluid H at the detection target region Ra.

The measurement target substance is processed such that it emits fluorescence when excited by external light irradiated thereon. The measurement target substance is detected by detecting the fluorescence.

Electrodes, for applying electrical potential differences to the sample fluid H to cause electrophoresis within the flow channels 110, are provided in each of the well apertures 107. An electrode A, and electrode B, and an electrode G are provided in the well apertures 107a, the well aperture 107b, and the well aperture 107g, respectively.

Next, analysis using electrophoresis by the electrophoresis analysis apparatus 300 and the change in control properties for temperature control prior to and following switching of flow channels will be described.

First, the control section 250 of the electrophoresis analysis apparatus 300 outputs a command to the temperature controlling section 220. The temperature controlling section 220 controls the Peltier element 230 to maintain the temperature of the sample fluid H within the main flow channel 110ag within a range of 20° C.±0.5° C., for example.

Next, the control section 250 outputs a command to the electrical potential difference applying section 210, while the temperature of the sample fluid H is maintained within the range of 20° C.±0.5° C. The electrical potential difference applying section 210 applies an electrical potential difference of 3000V between the electrodes A and G, by setting the electrode G to 0V, that is, grounding the electrode G, and by setting the electrode A to +3000V. Thereby, the main flow channel 110ag becomes an electrophoresis flow channel, and electrophoresis is caused to occur in the sample fluid H within the main flow channel 110ag.

Here, the temperature controlling section 220 controls the temperature of the sample fluid H within the main flow channel 110ag to be within the aforementioned predetermined range of 20° C.±0.5° C. The temperature controlling section 220 performs temperature control according to control properties that maintain the temperature of the sample fluid H within the range of 20° C.±0.5° C., factoring in the heat generation within the sample fluid H when the 3000V electrical potential difference is applied.

Note that here, it is desirable for the temperature controlling section 220 to maintain the temperature of the sample fluid H in both the main flow channel 110ag and the sub flow channel 110b within the range of 20° C.±0.5° C.

As illustrated in FIG. 3A, a specific component Ha within the sample fluid H moves toward the electrode G by electrophoresis, and becomes concentrated in a band like state close to the right end Tg of the main flow channel 110ag, past a branch Br where the sub flow channel 110b branches off from the main flow channel 110ag. The branch Br is where the sub flow channel 110b branches off from the main flow channel 110ag.

The movement of the specific component Ha to the right end Tg is detected by the detecting section 240. That is, the detecting section 240 detects the state in which the specific component Ha, which is concentrated in the band like state, moves toward the right end Tg as it passes through the detection target region Ra positioned between the branch Br and the right end Tg.

The detecting section 240, which has detected the passage of the specific component Ha, outputs detection results to the control section 250.

The control section 250, to which the detection results are input, outputs commands to the electrical potential applying section 210 and the temperature controlling section 220, to switch the flow channel to which an electrical potential difference is applied to a flow channel 110bg. The flow channel 110bg is a flow channel that includes the sub flow channel 110b, and the portion of the main flow channel 110ag from the branch Br to the right end Tg thereof. The flow channel 110bg is the flow channel in which the specific component Ha is contained, concentrated in the band like state.

The electrical potential applying section 210, which has received input of the command, set the electrode B to −1500V, and sets the electrode G to 0V, to apply a 1500V electrical potential difference between the electrodes B and G. Thereby, the flow channel 110bg becomes an electrophoresis flow channel, and electrophoresis is caused to occur in the sample fluid H within the main flow channel 110bg.

As illustrated in FIG. 3B, the specific component Ha, which is concentrated in the band like state within the sample fluid H, disperses and moves through flow channel 110bg toward the end b thereof by electrophoresis.

The temperature controlling section 220, to which the command to switch the electrophoresis flow channel to the flow channel 110bg has been input from the control section 250, controls the Peltier element 230 to maintain the temperature of the sample fluid H within the flow channel 110bg within the aforementioned range of 20° C.±0.5° C. The temperature controlling section 220 performs temperature control to maintain the temperature of the sample fluid H within the range of 20° C.±0.5° C., factoring in the difference in heat generation within the sample fluid H when the 3000V electrical potential difference and the 1500V electrical potential difference are applied. That is, the temperature controlling section 220 performs temperature control such that the temperature of the fluid sample H continues to be maintained within the range of 20° C.±0.5° C. after the electrophoresis flow channel is switched to the flow channel 110bg.

The specific component Ha is dispersed and moved toward the end b of the flow channel 110bg due to the application of the aforementioned electrical potential difference. The state of movement of the specific component Ha is detected by the detecting section 240. This detection enables analysis of the specific component Ha.

The difference in heat generation that occurs in the fluid sample when the electrical potential difference is applied to the main flow channel 110ag and when the electrical potential difference is applied to the flow channel 110bg is mainly the difference in the Joule heat which is generated due to electrical resistance when current flows through the fluid sample. That is, the amount of generated Joule heat within the main flow channel 110ag is determined by the electrical potential difference applied thereto, and the electrical resistance within the main flow channel 110ag. Similarly, the amount of generated Joule heat within the flow channel 110bg is determined by the electrical potential difference applied thereto, and the electrical resistance within the flow channel 110bg. Accordingly, the electrical resistance between two flow channels, to which electrical potential differences are applied, will be different if the lengths thereof are different, even if the cross sectional areas thereof and the electrical resistance of the fluid sample are uniform. The amount of heat generated per unit time within each of these two flow channels will be different, even if the same electrical potential difference is applied thereto.

Here, the changing of control properties for temperature control of the sample fluid within the electrophoresis flow channels performed by the temperature controlling section 220 will be described in detail.

FIG. 4 is a graph that illustrates temperature variations of the sample fluid in the case that the temperature controlling method of the present invention is applied and electrophoresis flow channels are switched. The graph of FIG. 4 is a coordinate system, in which the horizontal axis t represents time and the vertical axis α represents temperature. The temperature of the sample fluid within electrophoresis channels is illustrated prior to and following switching of flow channels. In FIG. 4, t11 indicates the timing at which the 3000V electrical potential difference is applied between the electrode A and the electrode G, and t12 indicates the timing at which the 1500V electrical potential difference is applied between the electrode B and the electrode G. Here, the timings at which the electrical potential differences are applied and the timings at which the control properties of temperature control are changed are matched.

As illustrated in FIG. 4, in the case that the temperature controlling method of the present invention is applied, the temperature of the sample fluid prior to the 3000V electrical potential difference being applied between the electrodes A and G (within the main flow channel 110ag)the temperature of the sample fluid within the electrophoresis flow channel following application of the 3000V electrical potential difference between the electrodes A and G (within the main flow channel 110ag), and the temperature of the sample fluid following application of the 1500V electrical potential difference between the electrodes B and G (within the flow channel 110bg) to switch the electrophoresis flow channels are all controlled to be within the range of 20° C.±0.5° C.

In contrast, a case that a conventional temperature controlling method, in which control properties for temperature control are not changed during switching of flow channels and the same control properties are continuously used to control temperature, that is, a case in which changes in heat generation within a sample fluid accompanying switching of electrophoresis flow channels are not factored, is applied, the temperature of the sample fluid within the electrophoresis flow channels varies as described below. FIG. 5 is a graph that illustrates temperature variations of the sample fluid in the case that the conventional temperature controlling method, in which the control properties are not changed when electrophoresis flow channels are switched, is applied. The graph of FIG. 5 is a coordinate system, in which the horizontal axis t represents time and the vertical axis α represents temperature. The temperature of the sample fluid within electrophoresis channels is illustrated prior to and following switching of flow channels. In FIG. 5, t21 indicates the timing at which the 3000V electrical potential difference is applied between the electrode A and the electrode G, and t22 indicates the timing at which the 1500V electrical potential difference is applied between the electrode B and the electrode G.

As illustrated in FIG. 5, the temperature of the sample fluid within the electrophoresis flow channel is controlled to be within a range of 20° C.±0.5° C. prior to a 3000V electrical potential difference being applied between the electrodes A and G (within the main flow channel 110ag). However, immediately after the 3000V electrical potential difference is applied between the electrodes A and G (within the main flow channel 110ag), the temperature of the sample fluid rises above 20° C.+0.5° C. Thereafter, the temperature of the fluid sample within the electrophoresis flow channel varies within a range Further, when a 1500V electrical potential difference is applied between the electrodes B and G to switch the electrophoresis flow channels, the temperature of the sample fluid within the electrophoresis channel fluctuates within a range that extends beyond 20° C.±0.5° C.

In this manner, there are cases in which the temperature of sample fluids within electrophoresis flow channels cannot be maintained within a predetermined temperature range, if temperature control is constantly performed without factoring in changes in heat generation within a sample fluid accompanying switching of electrophoresis flow channels.

The physical properties, such as viscosity, of fluid samples within electrophoresis flow channels change according to the temperature thereof. Accordingly, accurate electrophoresis cannot be performed by such an electrophoresis analysis apparatus, and the quality of analysis deteriorates.

Note that the timing at which the flow channel is switched need not necessarily be perfectly matched with the timing at which the control properties are changed. The timing at which the control properties are changed may be shifted either prior to or following the timing at which the flow channels are switched, within a range that does not hinder temperature control, that is, within a range that does not cause the temperature to rise or fall outside the predetermined temperature range. That is, the control properties may be changed before switching the flow channels, or after switching the flow channels.

In the case that the control properties for temperature control are changed before switching the flow channels, the detecting section 240 that detects the state of electrophoresis of the sample fluid may detect an appropriate timing before the switching of the flow channels for the control properties to be changed. A signal representing the detected timing may be output, and the temperature controlling section 220 may change the control properties according to the output signal. In addition, the timing at which the control properties are changed between the application of the 3000V electrical potential difference between the electrodes A and G, and the application of the 1500V electrical potential difference between the electrodes B and G may be determined in advance, uncorrelated with the detection by the detecting section 240.

In the case that temperature control is performed by PID control, the coefficient of each of P (Proportion), I (Integral), and D (Derivative) may be changed. Alternatively, the relationships among the passage of time prior to and following the switching of flow channels and electricity supplied to the Peltier element may be derived by experiments, computer simulations or the like. The relationships may be recorded in a look up table, and the control properties may be changed based on the information recorded in the look up table.

FIG. 6 is a diagram that illustrates an electrophoresis chip, in which two independent sets of micro flow channels that do not communicate with each other are formed.

The electrophoresis chip 102′ of FIG. 6 is that in which two independent sets of micro flow channels that do not communicate with each other are formed. The temperature controlling method of the present invention may also be applied to independent micro flow channels that do not communicate with each other and which are formed in a single electrophoresis chip 102′ as well.

That is, a first micro flow channel 110′ and a second micro flow channel 110″, which are similar to the micro flow channel 110, are faulted in the electrophoresis chip 102′, which is a single substrate. The micro flow channels 110′ and 110″ are capable of switching flow channels through which electrophoresis occurs by applying electrical potential differences. When the electrophoresis flow channel is switched from the first micro flow channel 110′ to the second micro flow channel 110″, temperature variations of the sample fluids within the first micro flow channel 110′ and the second micro flow channel 110″, caused by differences in heat generated by the sample fluids prior to and following the switching of the flow channels can be predicted in advance. Then, the control properties for temperature control can be changed in order to cancel the temperature variations during the switching of the flow channels.

Note that the factors that cause differences in heat generation within sample fluids in the flow channels prior to and following switching of the flow channels include differences in electrical resistances of the flow channels and differences in voltages which are applied between electrodes. The differences in electrical resistance are caused by differences in the electrical resistance of the sample fluid, differences in the cross sectional area of the flow channels, and differences in the lengths of the flow channels.

The method of the present invention may be applied in cases that the lengths and the cross sectional areas of the flow channels, in which electrophoresis is caused to occur, are different, and in cases that the lengths and cross sectional areas of the flow channels are the same.

As described above, the temperature controlling method of the present invention is a temperature controlling method for controlling the temperature of a sample fluid within flow channels of electrophoresis chips, in which flow channels in which electrophoresis is caused to occur by applying electrical potential differences are switchable. In the temperature controlling method of the present invention, temperature variations of the sample fluids within the micro flow channels, caused by differences in heat generated by the sample fluids prior to and following the switching of the flow channels, are predicted. The control properties for temperature control are changed in order to cancel the temperature variations during the switching of the flow channels. Therefore, temperature variations of sample fluids in which electrophoresis is caused to occur can be suppressed. Thereby, changes in the physical properties of the sample fluid, such as viscosity, can be suppressed. Accordingly, accurate electrophoresis can be realized, and deterioration in the quality of analysis by electrophoresis can be suppressed.

1-6. (canceled)

7. A temperature controlling method for controlling the temperatures of sample fluids within micro flow channels of electrophoresis chips, in which flow channels through which electrophoresis occurs by application of electrical potential differences can be switched, characterized by:
predicting temperature variations of the sample fluids within the micro flow channels, caused by differences in heat generated by the sample fluids prior to and following the switching of the flow channels; and
changing control properties for temperature control in order to cancel the temperature variations during the switching of the flow channels.

8. A temperature controlling method as defined in claim 7, characterized by:
the temperature control of the sample fluids being performed by employing a Peltier element.

9. A temperature controlling method as defined in claim 7, characterized by:
the electrical potential differences applied in the flow channels in which electrophoresis occurs being different prior to and following the switching of the flow channels.

10. A temperature controlling method as defined in claim 8, characterized by:
the electrical potential differences applied in the flow channels in which electrophoresis occurs being different prior to and following the switching of the flow channels.

11. A temperature controlling method as defined in claim 7, characterized by:
the electrical resistance within the flow channels in which electrophoresis occurs being different prior to and following the switching of the flow channels.

12. A temperature controlling method as defined in claim 8, characterized by:
the electrical resistance within the flow channels in which electrophoresis occurs being different prior to and following the switching of the flow channels.

13. A temperature controlling method as defined in claim 9, characterized by:
the electrical resistance within the flow channels in which electrophoresis occurs being different prior to and following the switching of the flow channels.

14. A temperature controlling method as defined in claim 10, characterized by:
the electrical resistance within the flow channels in which electrophoresis occurs being different prior to and following the switching of the flow channels.

15. A temperature controlling method as defined in claim 7, wherein:
the lengths of the flow channels in which electrophoresis occurs are different prior to and following the switching of the flow channels.

16. A temperature controlling method as defined in claim 8, wherein:
the lengths of the flow channels in which electrophoresis occurs are different prior to and following the switching of the flow channels.

17. A temperature controlling method as defined in claim 9, wherein:
the lengths of the flow channels in which electrophoresis occurs are different prior to and following the switching of the flow channels.

18. A temperature controlling method as defined in claim 10, wherein:
the lengths of the flow channels in which electrophoresis occurs are different prior to and following the switching of the flow channels.

19. A temperature controlling method as defined in claim 11, wherein:
the lengths of the flow channels in which electrophoresis occurs are different prior to and following the switching of the flow channels.

20. A temperature controlling method as defined in claim 12, wherein:
the lengths of the flow channels in which electrophoresis occurs are different prior to and following the switching of the flow channels.

21. A temperature controlling method as defined in claim 13, wherein:
the lengths of the flow channels in which electrophoresis occurs are different prior to and following the switching of the flow channels.

22. A temperature controlling method as defined in claim 14, wherein:
the lengths of the flow channels in which electrophoresis occurs are different prior to and following the switching of the flow channels.

23. A temperature controlling method as defined in claim 7, wherein:
the control properties for temperature control are changed either prior to or following the switching of the flow channels.

24. A temperature controlling method as defined in claim 8, wherein:
the control properties for temperature control are changed either prior to or following the switching of the flow channels.

25. A temperature controlling method as defined in claim 9, wherein:
the control properties for temperature control are changed either prior to or following the switching of the flow channels.

26. A temperature controlling method as defined in claim 10, wherein:
the control properties for temperature control are changed either prior to or following the switching of the flow channels.

27. A temperature controlling method as defined in claim 11, wherein:
the control properties for temperature control are changed either prior to or following the switching of the flow channels.

28. A temperature controlling method as defined in claim 12, wherein:
the control properties for temperature control are changed either prior to or following the switching of the flow channels.

29. A temperature controlling method as defined in claim 13, wherein:
the control properties for temperature control are changed either prior to or following the switching of the flow channels.

30. A temperature controlling method as defined in claim 14, wherein:
the control properties for temperature control are changed either prior to or following the switching of the flow channels.

31. A temperature controlling method as defined in claim 15, wherein:
the control properties for temperature control are changed either prior to or following the switching of the flow channels.

32. A temperature controlling method as defined in claim 16, wherein:
the control properties for temperature control are changed either prior to or following the switching of the flow channels.

33. A temperature controlling method as defined in claim 17, wherein:
the control properties for temperature control are changed either prior to or following the switching of the flow channels.

34. A temperature controlling method as defined in claim 18, wherein:
the control properties for temperature control are changed either prior to or following the switching of the flow channels.

35. A temperature controlling method as defined in claim 19, wherein:
the control properties for temperature control are changed either prior to or following the switching of the flow channels.

36. A temperature controlling method as defined in claim 20, wherein:
the control properties for temperature control are changed either prior to or following the switching of the flow channels.

37. A temperature controlling method as defined in claim 21, wherein:
the control properties for temperature control are changed either prior to or following the switching of the flow channels.

38. A temperature controlling method as defined in claim 22, wherein:
the control properties for temperature control are changed either prior to or following the switching of the flow channels.
